(19) United States
(12) Patent Application Publication
(10) Pub. No.: US 2002/0010624 A1
(43) Pub. Date: Jan. 24, 2002

(54) Advertisement providing method and system therefor

(76) Inventors: Yasushi Tomita, Mito (JP); Yasushi Harada, Hitachi (JP); Harumi Uchigasaki, Hitachinaka (JP); Chihiro Fukui, Hitachinaka (JP); Yutaka Kokai, Hitachinaka (JP); Nobuhisa Kobayashi, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/812,084

(22) Filed: Mar. 20, 2001

(30) Foreign Application Priority Data
Jul. 21, 2000 (JP) 2000-220032

(51) Int. Cl. G06F 17/60

(52) U.S. Cl. 705/14

(57) ABSTRACT

An advertisement providing method is capable of providing information from an advertiser by selecting information adapting to the customer in response to a demand for information from the customer from the customer, efficiently. The method comprises checking whether a customer on access has a contract for using the information, permitting access to the information when the customer holds contract for using the information, for permitting retrieval of information registered as advertisement information by an advertiser depending upon the demand of the customer, optionally demanding additional information to the advertiser, delivering resultant information to the customer, and performing billing process for the customer and/or advertiser depending upon access record and delivery record of the customer.

### BACKGROUND OF THE INVENTION

The present invention relates to a technology for providing advertisement.

As the conventional technology for providing advertisement information, there are advertisement on a newspaper, advertisement insert in the newspaper, a homepage and so forth.

One of the conventional technology has been disclosed in Japanese Unexamined Patent Publication No. Heisei 11-66168 (hereinafter referred to as prior art A)

Disclosed in the prior art A is a system for mediating distribution of information between a source of information relating to buying of commercial products of customers and business enterprise desiring to obtain such information. The system manages information of particular items of general customers and permits persons desiring access to the data base, namely business enterprises who are authorized to access under contract and bills for the access.

On the other hand, there is another technology disclosed in U.S. Pat. No. 5,948,061 (hereinafter referred to as prior art B. Disclosed in the prior art B is an advertisement system which may vary content of advertisement depending upon profile characteristics of a user who is in access and to show different advertisement depending upon number of times of access of the user.

In these prior arts, wide range information is provided irrespective whether the customers are attracted attention or not. This is not providing information with selecting the customer or responding to a demand of the customer. Therefore, it cannot be said optimal in viewpoint of efficiency of advertisement.

Particularly, while the prior art B varies advertisement depending upon the profile of the customer, access to certain information may not serve as a trigger for advertisement display. Therefore, it is not possible to provide information adapting to interest of the customer or level of interest of the customer.

On the other hand, in the recent years, services and electric products conscious for saving energy are marketed. However, when advertisement of the service or electric product is provided, it is not possible to provide advertisement information of service or advertisement information of the electric products adapting to lift style of the customer. For example, in the prior art, even for power consumption of one living alone, advertisement information of chest freezer is given to lower advertisement efficiency.

### SUMMARY OF THE INVENTION

An object of the present invention is to provide a method and a system for providing advertisement which can provide information adapted to demand of the customers.

Another object of the present invention is to provide a method and system for proving advertisement information for electric power customer with high advertisement efficiency, namely providing advertisement information adapting to needs of customer or life style of the customer.

According to the first aspect of the present invention, an advertisement providing method for providing advertisement from an advertiser to an electric power customer comprises the steps of:

receiving a power consumption data from a sensor measuring a power consumption amount of the electric power customer or from an electric power supplier; and

selecting an advertisement to be provided to the electric power customer from preliminarily registered in a database on the basis the power consumption data.

In the preferred construction, the selected advertisement is provided to the electric power customer through a communication circuit. Number of times of communication or a communication period may be recorded and a charge calculation may be performed depending upon recorded number of times of communication or communication period.

In the advertisement providing method, providing of advertisement through the communication circuit may be performed by one of placement on a homepage and transmission through facsimile. An advertisement placed on the home page may be permitted by prompting input of an identifier for proving identity of the electric power customer, retrieving the input identifier against a database storing identifiers preliminarily assigned for the electric power customers, and enabling access to the homepage only when the input identifier is present in the database.

The advertisement may be provided in response to a demand of the electric power customer. The selection of advertisement is an advertisement of products assisting power saving of the electric power customer.

According to the second aspect of the present invention, an advertisement providing system for providing an advertisement from an advertiser to an electric power customer comprises:

a receiving portion receiving a power consumption data from a sensor measuring a power consumption amount from the electric power customer or an electric power supplier;

a database storing advertisements of advertisers; and

means for selecting advertisement to be provided to the electric power customer among advertisements stored in the database on the basis of an electric power consumption data received by the receiving portion.

The advertisement providing system may further comprise database storing destination of transmission of advertisement per electric power customer for transmitting the selected advertisement to the transmission destination of the electric power customer. Transmission of the advertisement may be performed via facsimile. Transmission of the advertisement may be performed in response to a demand of the customer.

The advertisement providing system may further comprise:

means for recording number of times of transmission or transmission period in a recording medium; and

means for performing charge calculation depending on recording number of times of transmission or transmission period.

The advertisement providing system may further comprise means for placing the selected advertisement on a homepage. The advertisement providing system may further comprise means for prompting input of an identifier indicative of identity of the electric power customer as access condition of the homepage placed thereon the selected advertisement database storing the identifier assigned for each electric power customer, and means for enabling access of the homepage upon presence of the input identifier in the identifier storing database as a result of retrieval of input identifier against the database.

The advertisement may contain information of products or service consuming an electric power, and the selecting means may select advertisement of products lowering of power consumption amount of the electric power customer.

According to the third aspect of the present invention, an advertisement providing method providing information from an advertiser by selecting information adapting to the customer in response to a demand for information from the customer from the customer, comprises the steps of:

checking whether a customer on access has a contract for using the information;

permitting access to the information when the customer holds contract for using the information, for permitting retrieval of information registered as advertisement information by an advertiser depending upon the demand of the customer;

optionally demanding additional information to the advertiser;

delivering resultant information to the customer; and

performing billing process for the customer and/or advertiser depending upon access record and delivery record of the customer.

Check may be performed whether information retrieval demanded by the customer falls within a scope of contract for discriminating demand for information retrieval out of contract when the customer's demand requires retrieval output contract, and performing billing process for retrieval out of contract during billing process. A depth of retrieval performed in response to the demand of the customer may recorded and billing is performed depending of the recorded depth of retrieval during billing process.

A statistical analysis process may be performed in response to a demand from the customer and a result of analysis is provided to the customer together with associated advertisement information. An additional information from the advertiser may be registered in response to a demand from the customer, and an additional advertisement charge is billed to the advertiser.

According to the fourth aspect of the present invention, an advertisement providing system for providing information to a customer with selecting information from an advertiser adapting to a demand from the customer in response the customer's demand, which advertisement providing system connected to the advertiser through a communication line, comprises an advertisement service center which includes

a customer authenticating portion for checking whether the customer on access holds a use contract for permitting access only when the customer on access holds use contract;

an advertisement information storage file storing information registered by the advertiser as advertisement information for retrieval in response to demand from the customer;

an additional information demanding portion demanding additional information to the advertiser when the demand of the customer is not contained in the advertisement information storage file; and

a billing process portion performing billing process to the customer and/or advertiser on the basis of an access record and/or delivery record.

The advertisement service center further may include a statistical analyzing portion performing statistical analysis process depending upon demand of the customer. The advertisement service center may further include a customer billing process portion performing billing process on the basis of a record of access within a contract or out of contract.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a schematic block diagram showing an overall construction of an advertisement service system according to the present invention;

FIG. 2 is an illustration showing general construction of a service center AC;

FIG. 3 is a flowchart for explaining retrieving and obtaining preliminarily registered advertisement information;

FIG. 4 is an illustration for explaining rank of contract and predetermined available information;

FIG. 5 is n illustration for explaining data structure;

FIG. 6 is an illustration for explaining preparation of information in the case where depth of retrieval is deep;

FIG. 7 is a flowchart for explaining a process of analysis information service;

FIG. 8 is an illustration for showing an example of statistical analysis;

FIG. 9 is an illustration showing an example of display of a retrieval result screen image;

FIG. 10 is an illustration showing an example of display of a retrieval result screen image;

FIG. 11 is a process flowchart for explaining a billing process to the customer;

FIG. 12 is an illustration for detecting use condition per customer and to be a base of billing calculation;

FIG. 13 is a flowchart for explaining charging process for an advertiser;

FIG. 14 is an illustration for detecting condition of advertisement to be used for the advertiser;

### DESCRIPTION OF THE PREFERRED EMBODIMENTS

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

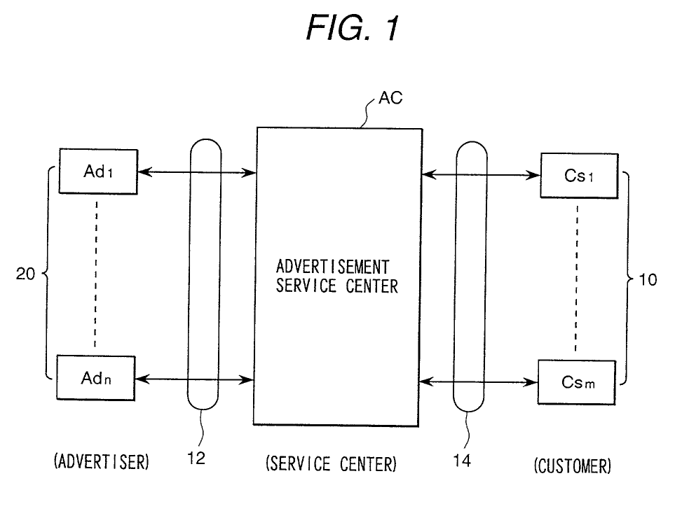

FIG. 1 is a schematic block diagram showing an overall construction of an advertisement providing system (advertisement service) system according to the present invention. The reference numeral 10 denotes customers as generally referred to. In the following disclosure, each individual customer is identified reference sign CS1 to CSm. The customer accesses advertisement service provider (advertisement service center) AC via an internet 14 as communication means, for example, to obtain information, which the customer desires to obtain. It is not rate that the customer cannot be satisfied by the already registered information. It is possible that the customer may desire to obtain information at different viewpoint. Also, it is possible that the customer demands more detailed information for obtaining more fulfilling information. The present invention is characterized to provide advertisement system, which can fulfill such demand of the customer.

The reference numeral 20 denotes an advertiser as generally referred to. Each individual advertiser will be identified by reference sign Ad1 to And. The advertisers 20 are registered in the service center AC and are connected to the service center AC through a communication network, such as the internet 12 for providing information to the service center AC. Also, the advertiser 20 may update advertisement information voluntarily. It is also possible to supplement non-registered information in response to a request of the service center AC.

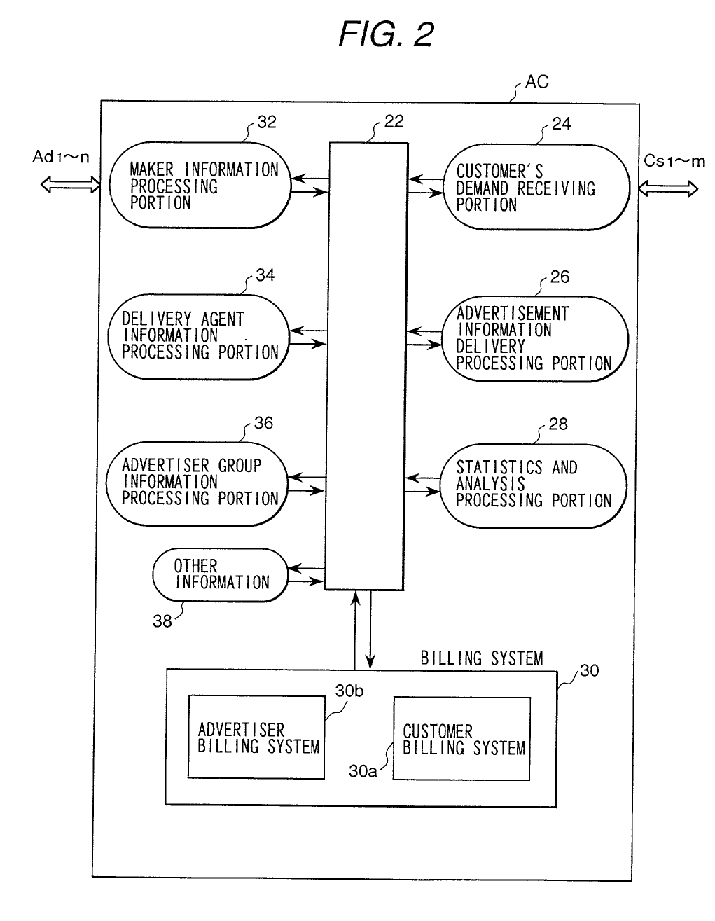

FIG. 2 is an illustration showing general construction of a service center AC. A central processing portion 22 is constructed with a computer and is a portion to provide advertisement information and to perform statistical and analyzing process. A customer demand receiving portion performs authentication by checking whether the customer in access is an authorized customer registered in the service center AC or not and roughly checks what information is required. The reference numeral 26 denotes a distribution processing portion for distributing advertisement information for the customer and other information to the customer. Information for the customer including analysis information is provided to the customer through a processing portion. The reference numeral 28 denotes a statistical analysis processing portion, which performs statistical analysis in response to demand of the customer or voluntarily by the service center. Namely, the statistical analysis processing portion performs trend analysis or analysis demanded by the customer for providing answer to the customer. As a library, numerical process library, clustering analysis library, a domestic power consumption model analysis library, an interface of analysis screen image and so forth may be provided. Detail of those libraries will be discussed later.

The reference numeral denotes a maker information processing portion. Advertisers may be in various business category. However,here,it is assumed that the shown embodiment of the advertisement system handles advertisement information of makers or manufacturers. The reference numeral 34 denotes a delivery agent or sales agent information processing portion. In the shown embodiment, the delivery agent or sales agent information processing portion may handle information relating to retail distributor or dealer and/or wholesale distributor or dealer. In certain case, schedule information, such as memorial sale, bargain sale and so forth, may also be provided. The customer may arbitrarily access those information to obtain desired information. The reference numeral 36 denotes a group information relating to a group consisted of a plurality of advertisers, e.g. business enterprise group information, such as shopping street information, associated business enterprise group information, in which information of respective individual shops or business enterprises are provided in aggregated manner. The reference numeral 38 denotes other information processing portion. The reference numeral 30 denotes an account processing portion, which is constructed with an account processing system 30a for processing accounting for the customer who is in access for obtaining information, and a account processing portion 30b for processing account of the advertisers registered in the service center AC.

In the shown embodiment, exchange of information is performed with constructing the advertisement service center AC as set forth above. The advertisement service center AC mainly performs the following services.

(1) Among information that the advertisers provide to the service center AC, the customer may retrieve desired information to obtain resultant information of retrieval.

(2) When the customer desires to obtain further detailed information after obtaining information resulting from retrieval, the customer may demand further information in interactive manner to obtain further detailed information. For example, upon purchasing home electric product, the customer may be provided information such as popularity, new product information and release schedule thereof.

(3) When the customer designates statistical analysis condition, the service center AC performs a trend statistical process or trend analyzing process and provides the result to the customer.

(4) On the basis of information relating electrical household appliances and electrical equipment provided from the customer, the customer may be provided information relating to replacement timing, prediction of life, maintenance or so forth.

(5) In addition, information depending upon demand of the customer may be provided.

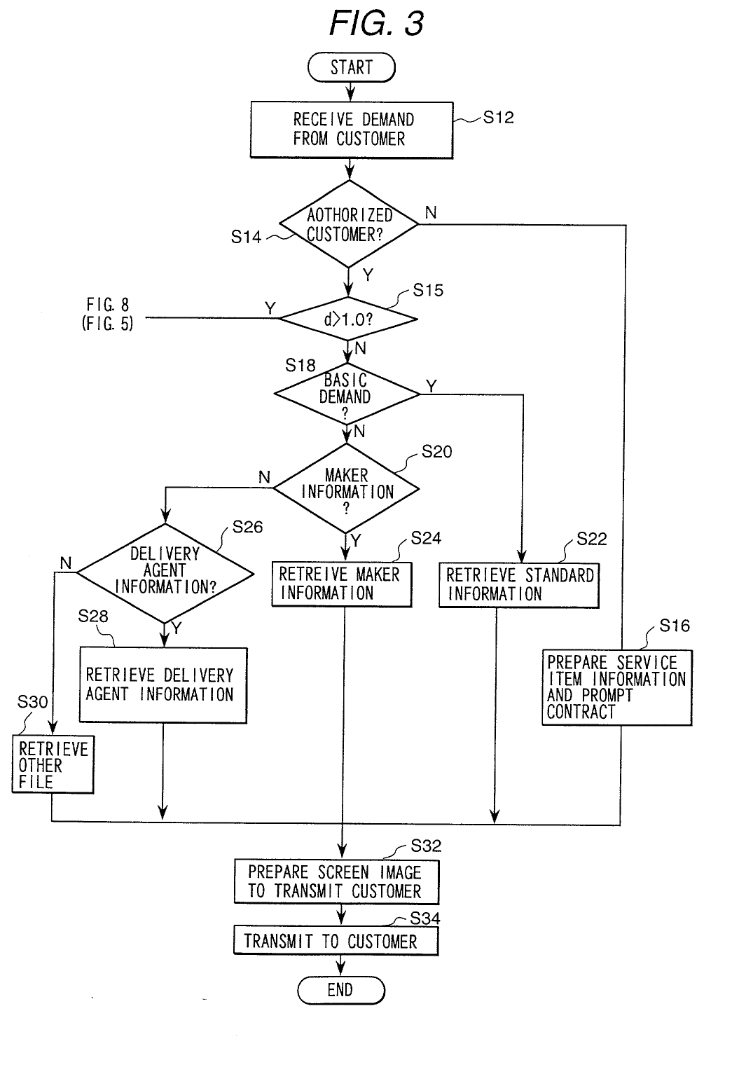

At first, discussion will be given for the case where the customer retrieves information of advertisers registered in the service center for obtaining information. FIG. 3 is a flowchart for explaining the process in this case. At step S12, a demand from the customer transmitted through a communication network, such as internet or the like, is received. Then, at step S14, authentication of the customer may be performed whether the customer requesting the information is the authorized customer under contract. Step S15 makes judgment whether the customer requires further detailed information for the information already provided to be customer once. Here, degree of detail of information is handled as depth d of retrieval. In data structure, information indicative of degree of detail is transmitted from the customer to the service center AC in a form of data as shown in FIG. 5, for example. The service center makes judgment of the required depth of retrieval depending upon the data shown in FIG. 5. At step S15, check is performed whether d>1.0 or not. If d=1.0, it represents retrieval of the advertisement information in a range preliminarily registered in the service center AC by the advertiser. On the other hand, if d>1.0, it represents presence of request of the customer for any additional information or information resulting from investigation and analysis to the advertiser. Accordingly, if the answer at step S15 is NO (N), it represents the case where the information is selected among already registered information and if the answer at step S15 is YES (Y), it represents request for information more than that already registered in the service center AC. The process when the answer at step S15 is YES will be discussed later with reference to FIG. 5.

When the customer who is attempting to access, has no contract and thus is not authorized to result in failure of authentication. Then, process is advanced to step S16 to service item information and information encouraging establishment of contract is prepared. On the other hand, if authentication is successful for login by authorized password or other way and authority of the accessing customer is confirmed and if the retrieval depth d is not greater than 1.0, check is performed at step S18 whether the demand is basic demand matter with in a range of established contract which the accessing customer holds.

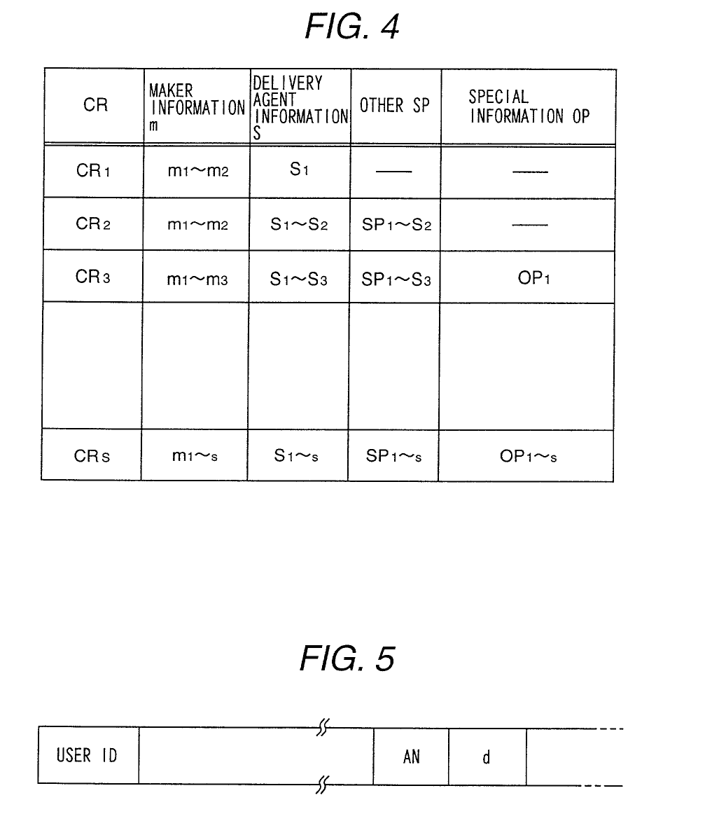

The basic matter is the basic information shown in FIG. 4, for example, among information preliminarily registered by the advertiser. The basic matter is variable depending upon the content of contract. For example, depending upon rank of contract CR (CR1 to CRS), information to be retrieved and obtained is differentiated. The contract rank CR1 is the lowest rank contract, in which the basic information m1 can be obtained as a maker information and a basic information s1 can be obtained as delivery agent information S. On the other hand, the basic demand matter in the contract rank CR3 is to obtain information m1 to m3 as the maker information m, information s1 to s3 as the delivery agent information s, and in addition, information sp1 to sp3 as other information sp and information op1 as optional information op. As set forth, depending upon rank of contract, amount and kind of information to be obtained is variable. Accordingly, if the demand given by the accessing customer falls within the basic demand matter according to the contract, retrieval of regular pattern information is permitted at step S22. Of course, depending upon contract range, a basic contract fee is different. Accounting will be discussed later. Even if it is found that the demand of the customer goes beyond the basic demand matter based on the contract after checking the demand of the customer at step S18, the customer may receive service exceeding a scope of the contract. Of course, account may be considered separately. Concerning information exceeding the contract, check is performed whether the demanded information is that relating to the maker or not at step S20. If the demanded information is the maker information, retrieval of maker information file beyond the scope of contract is permitted at step S24.

On the other hand, if the demanded information is not the maker information as checked at step S20, check is again performed whether the demanded information is delivery agent information or not at step S26. If the demanded information is the delivery agent information, retrieval of the delivery agent file (34 of FIG. 2) is permitted at step S28. If the demanded information is neither the maker information nor delivery agent information, retrieval of other file is permitted at step S30. Then, at step S32, data and image including a display image of information resulting from retrieval or information of service item and information encouraging establishment of contract, for responding to the customer's demand is prepared. Then, these data is transmitted to the customer via a advertisement information delivery processing portion 26 of FIG. 2.

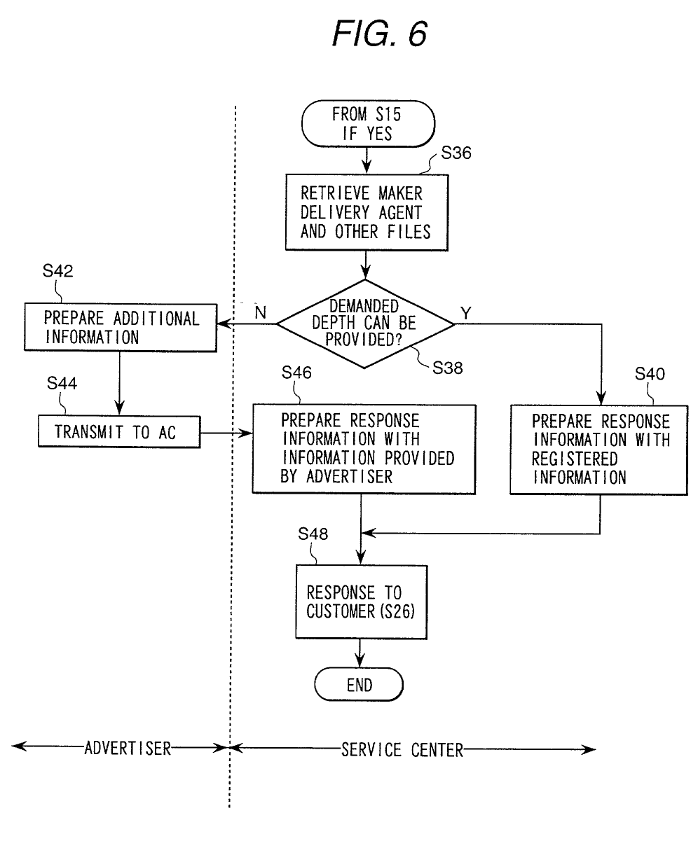

Next, discussion will be given for the case where the retrieval depth d as checked at step S15 is d>1.0 with reference to FIG. 6. At step S36, retrieval is performed against the maker file, the delivery agent file and other files. Then, at step S38, judgment is made whether the existing advertisement information is sufficient for fulfilling the customer's demand. If the existing advertisement information is sufficient, response information is prepared using the already registered information at step S40. If judgment is made at step S38 that the existing information is not sufficient for fulfilling the customer's demand, request for additional information is fed to the advertiser. In response to this, the advertiser prepares required additional information at step S42. At this step, a computer system in the advertiser may perform retrieval against its own data base or the like to prepare the additional information fulfilling the customer's demand. Then, the additional information thus prepared is transmitted from the advertiser to the service center AC at step S44. The service center AC is responsive to the additional information from the advertiser to prepare a response information at step S46 on the basis of the additional information provided by the advertiser. The response information is then provided to the customer at step S48. While it will be discussed in discussion for the accounting process later, a rate of charge is different depending upon the retrieval depth, depth of retrieval will be taken into account upon billing to the customer.

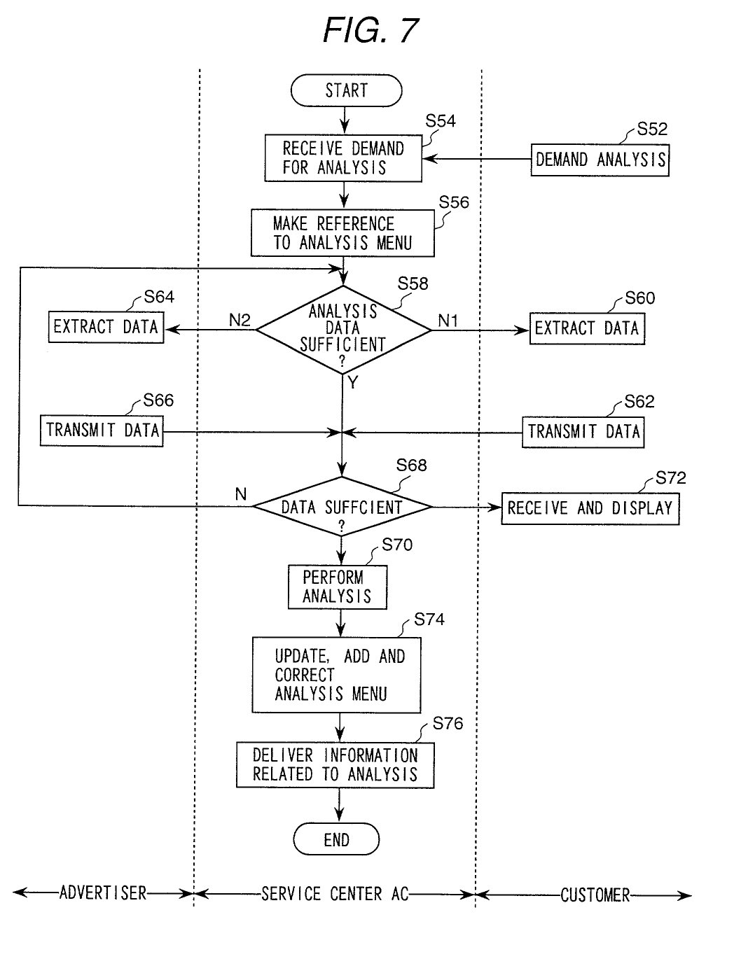

Next, discussion will be given for the case where statistical analysis process is demanded by the customer with reference to the flowchart shown in FIG. 7. As set forth above, the customer may demand statistical analysis information in addition to the normal advertisement information. When analysis is demanded by the customer at step S52, the service center AC is responsive to the demand for analysis at receiving step S54. At this step, judgment is made that analysis information is demanded on the basis of data AN of FIG. 5 which represents that analysis information. At step S54, authentication process and contract rank checking process and so forth for checking authority of the demanding customer are performed simultaneously for receiving the demand. At step S56, reference is made to a preliminarily prepared analysis menu for checking whether the analysis demanded by the customer is included in the analysis menu or not.

If the demanded analysis is included in the analysis menu, check is performed whether the data provided by the customer is sufficient for performing the demanded analysis or not at step S58. If not sufficient, and when judgment is made that data has to be required to the customer (N1), lacking data is required to the customer. On the other hand, if judgment is made that lacking data is to be required to the advertiser (N2), supplement information is requested to the advertiser. The advertiser or customer required additional data performs retrieval at step 64 or 60 against own database to transmit data to the service center AC at step 66 or 62. The service center AC again checks whether all of data necessary for analysis is provided at step S68. If data is still lacking, process returns to step S58 to require further data to the advertiser or customer. This loop may be continued until all necessary data is provided. When all necessary data is obtained, analyzing process is performed at step S70. In this case, since the analysis to be performed in that contained in the analysis menu, it is merely required correction of already made analysis in most case as performing analysis at step S70. The result of analysis is delivered to the customer via the advertisement information delivery processing portion 26 of FIG. 2. On the side of the customer, the result of analysis is displayed at step S72. With the result of analysis, data of the analysis in the analysis menu is updated for future use at step S74.

The shown system is characterized by service of the result of analysis in response to request of the customer and providing information with advertisement information relating to the analysis. For example, when the customer requests to the advertisement service center to make analysis of power consumption of house hold electric appliance which the customer own, the information relating to analysis is delivered to the customer together with information preliminarily corresponded to the provided analysis information, e.g. from the maker how energy consumption has been improved in new products or product name, or information from delivery agent sale of product of improved power saving performance. At step S76, delivery of information is performed. Therefore, the customer may obtain associated information together with analysis data. This may eliminate necessity of the customer's effort in retrieving associated advertisement information in view of the result of analysis. In other words, advertisement information is added to the analysis result with estimating what advertisement information will be desired to be obtained when the customer see the result of analysis.

A customer information related with provided associated advertisement information is used in providing associated advertisement information with the demanded information when power consumption information of the customer (power consumption curve, power consumption curve per application), comparison information with other customer (comparison with other customer having the same contract demand, or comparison information with an average value in the same area) or trial calculation information of electricity charge upon changing of electricity charge package plan. As set forth above, it is possible to deliver information corresponded to information transmitted from the customer to the service center AC or demanded information. This contributes for reducing number of times of exchanging information between the service center AC and customer.

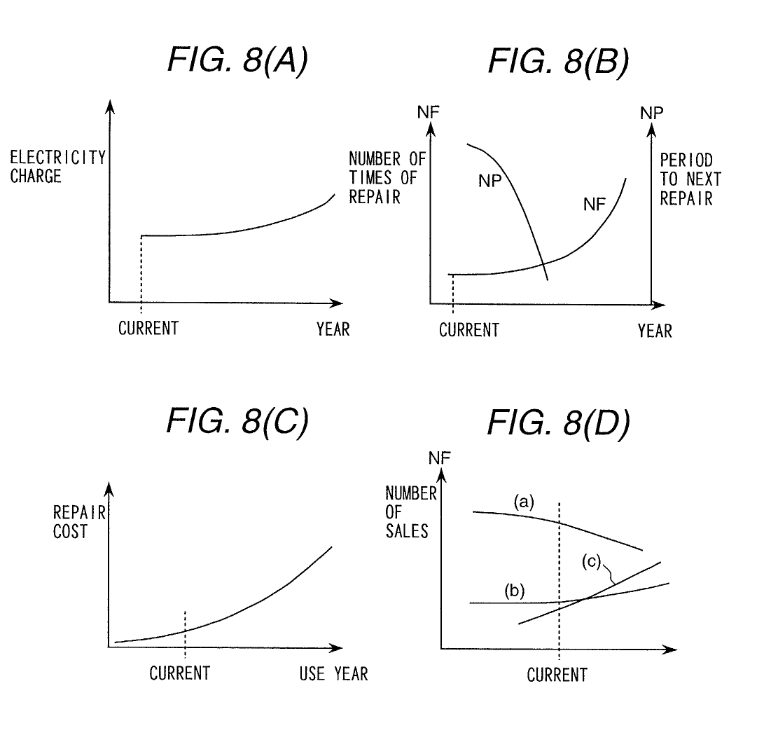

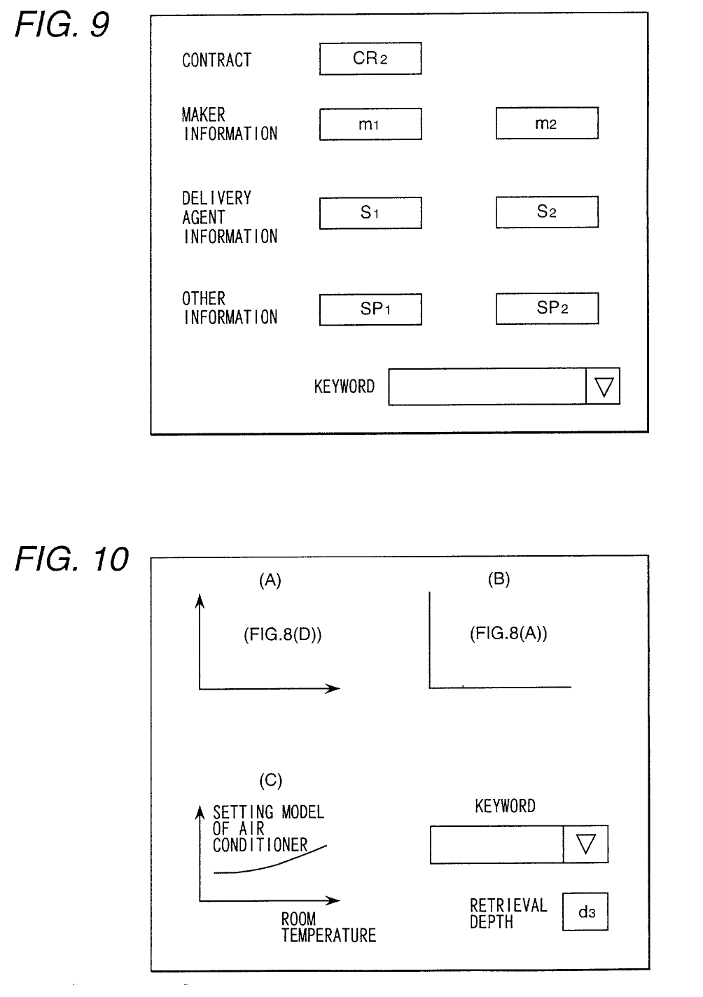

FIGS. 8A to 8D show examples of statistical analysis data. FIG. 8A shows an expected variation of electricity charge for each specific electric appliance. For instance, when information of specification, purchase year, model, maker and so forth of air conditioner to the advertisement service center AC, expected variation of the electricity charge from now when the existing air conditioner is continuously used. Such data may be useful for the customer in making judgment of replacement timing. Similarly, FIG. 8B shows an expected variation of frequency of repair. In FIG. 8B, there are shown expected number of times of repairing NF and expected length of interval to next repairing NP. Therefore, the customer may use such information in considering replacement timing on the basis of expected frequency of repairing toward the future. On the other hand, FIG. 8C shows an example of expected variation of repair cost toward the future. Such expected variation of repair cost may be derived if the repair cost data in the past of the electric appliance in question by the customer. FIG. 8D show variation of sales of electric appliances of various makers. In the shown example in FIG. 8D, a product of maker (a) has been released at the earliest timing and descending in sales. A product of maker (b) has been released later than the product of maker (a) and gradually or moderately increases sales. A product of maker (c) has released at the latest timing but shows ascending of sales. The customer may know popularity of each products to provide idea for the customer in buying the electric appliance or development of new product.

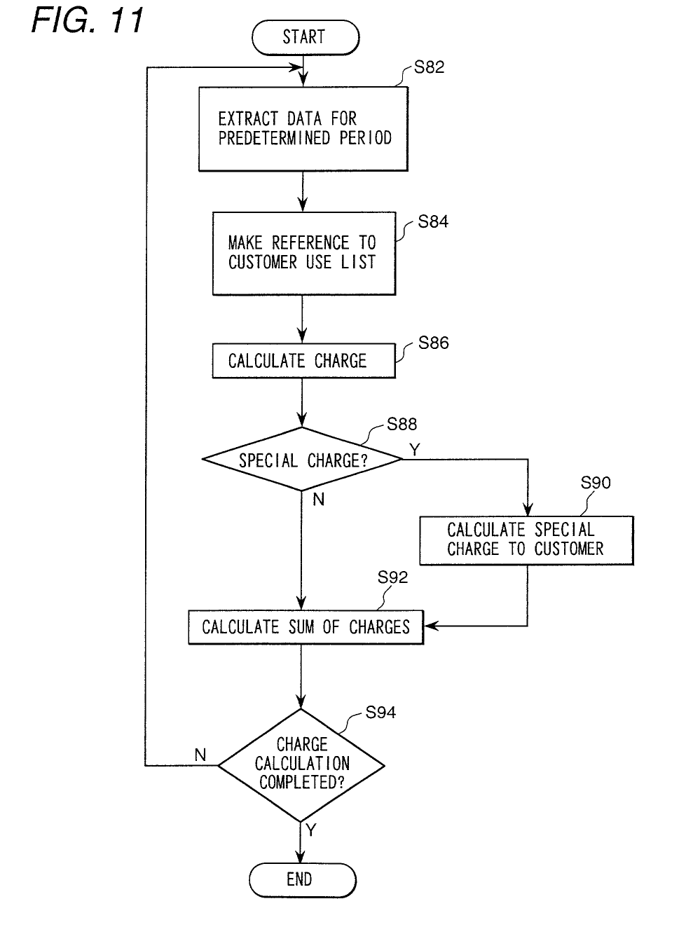

FIGS. 9 and 10 show example of display screens. FIG. 9 shows an example of display of the case of contract rank CR2 in FIG. 4. In a response screen image of the basic matters under the contract CR2, the maker information m1 and m2, the delivery agent information s1 and s2 and other information sp1 and sp2 are provided. If further detailed information or information at different viewpoint is desired, keyword is selected or input in a keyword column. Then, retrieval output contract may be permitted to enabling obtaining necessary information. FIG. 10 shows another example of display screen. In FIG. 10, (A) shows a trend data corresponding to data shown in FIG. 8D. (B) in FIG. 10 shows variation of electricity charge toward the future when use of the existing electric appliance is continued. (C) in FIG. 10 shows a answer to a demand for a model of set temperature of air conditioner by the customer. If the customer wants to obtain further detailed information, keyword or the like is input to the keyword column. If authentication is successful, then the customer is permitted to obtain the desired information. FIG. 10 shows the case where retrieval depth is d3. This retrieval depth is taken into account upon billing.

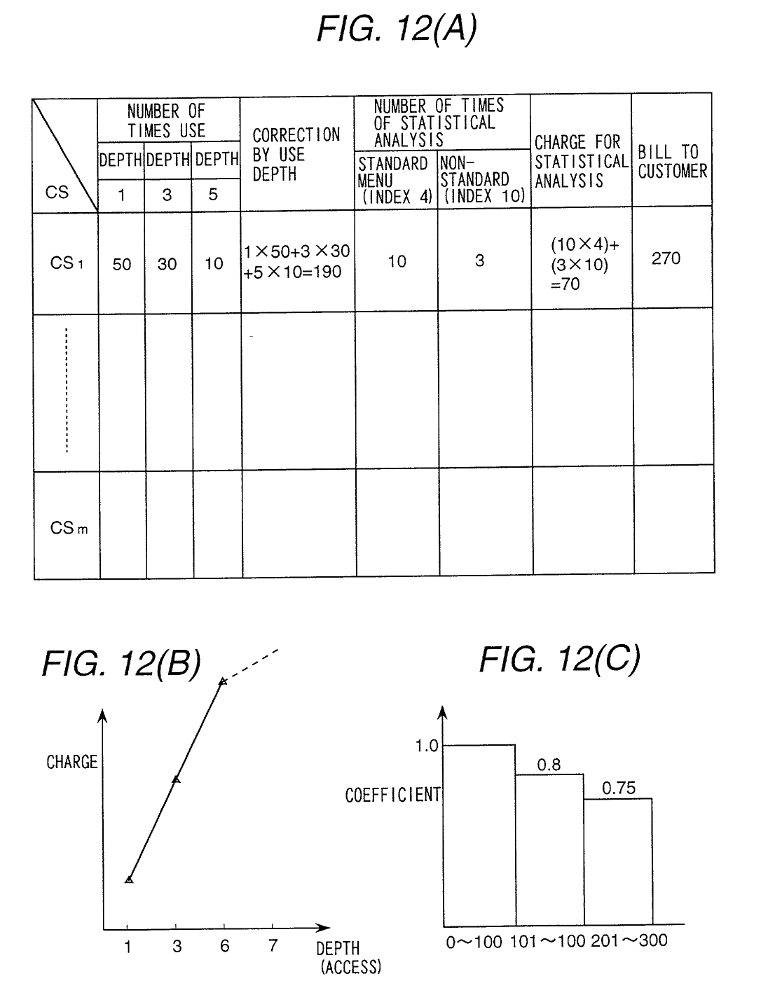

FIG. 11 is a flowchart for explaining calculation for billing to the customer. At step S82, use condition per customer over a predetermined period is extracted. When the customer uses the information service, record of use is maintained in time sequence. Therefore, by checking the record, use condition per customer can be appreciated. For example, as shown in FIG. 12A, data per customer can be collected. At step S84 of FIG. 11, data per customers CS1 to CSm is prepared as shown in FIG. 12A. Here, discussion will be given for the case for billing to the customer CS1. At step S86, calculation for billing to the customer is performed. For example, when the customer used information in retrieval depth 1 for fifty times, in retrieval depth 3 for thirty times, and in retrieval depth 5 for ten times. In such case, charge for use becomes (1×50+3×30 +5×10)=190. By this, bill calculation can be performed with taking the retrieval depth into account. In FIG. 12A, columns next to calculation of use charge are used data of statistical analysis. In the shown example, the customer has used analysis in standard menu (index 4) for ten times and analysis out of standard menu (index 10) for three times. In such case, charge for statistical; analysis becomes (4×10+10×3)=70. Accordingly, for the customer CS1, the charge in the shown period becomes 270. By multiplying this value with a charge per unit information amount, actual charge to be billed can be calculated. For example, assuming that the charge for the unit information amount is ¥100, bill amount to be charged to the customer CS1 for the service in the shown period becomes ¥2,700. Such charge calculation is performed at step S86.

Here, discussion will be given about relationship between the retrieval depth and the charge. For example, as shown in FIG. 12B, greater retrieval depth requires higher charge. It is also possible to reduce charge for unit information amount at greater number of times of use per a predetermined period. In an example shown in FIG. 12C, a discounting coefficient is set at 0.8 for use in one hundred one to two hundreds times, discounting coefficient is set at 0.75 for use in two hundreds one to three hundred times.

At step S88, check is performed whether the use of the customer in question contains item subject to special charge. Here, the special charge is caused for use in higher degree of urgency or the demand of the customer requires data from external organization which incurs extra charge. If special charge item is included in the use of the customer in the period of question, special charge is extracted at step S90. The special charge thus extracted is added to the charge calculated at step S86 at step S92. There after, check is performed whether calculation of charge for all customers is completed or not at step S94.

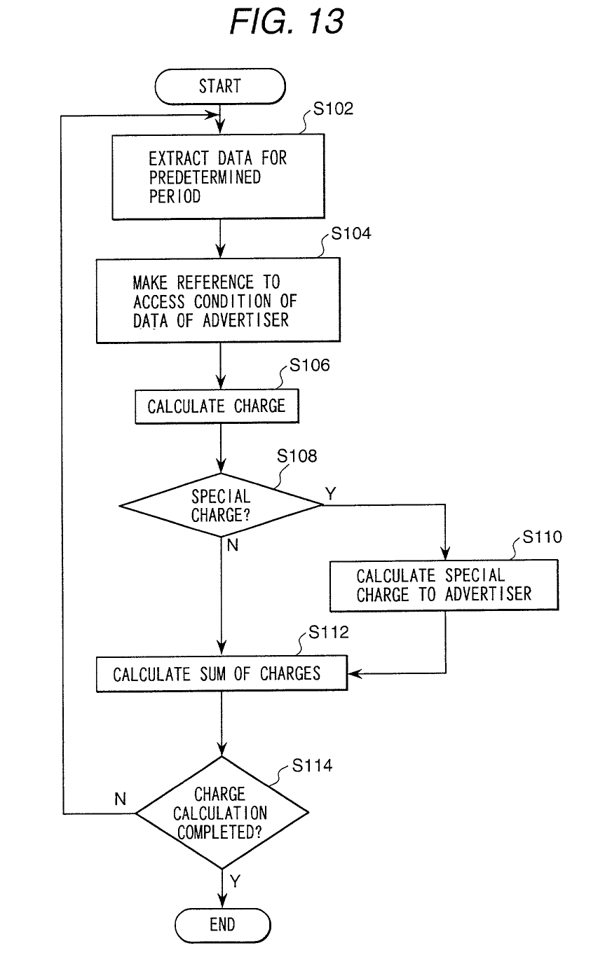

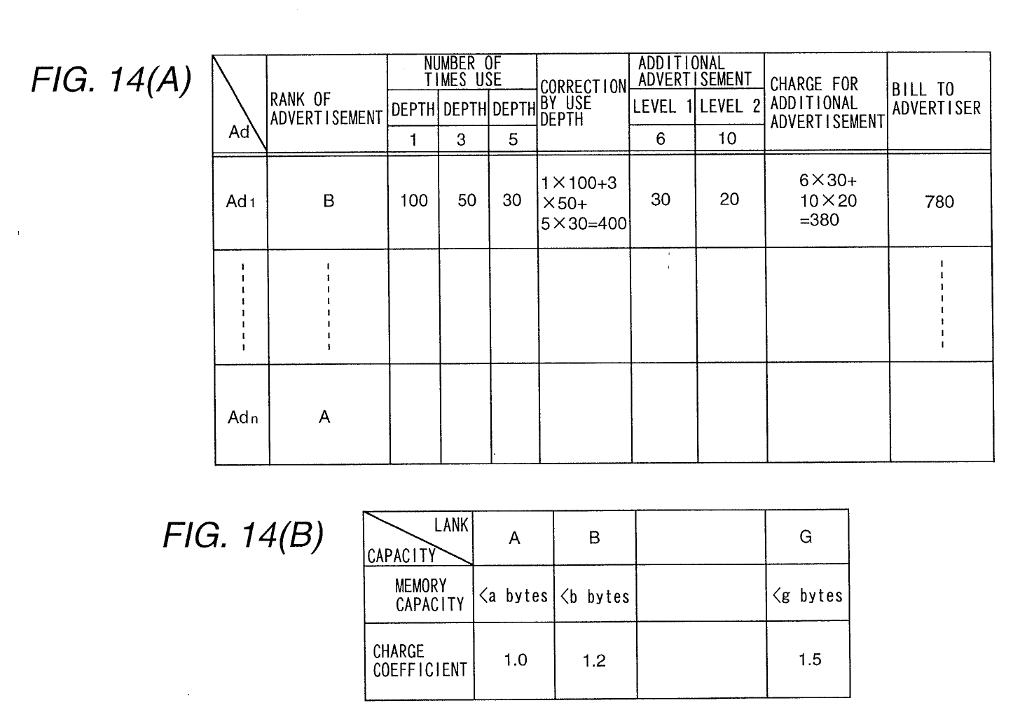

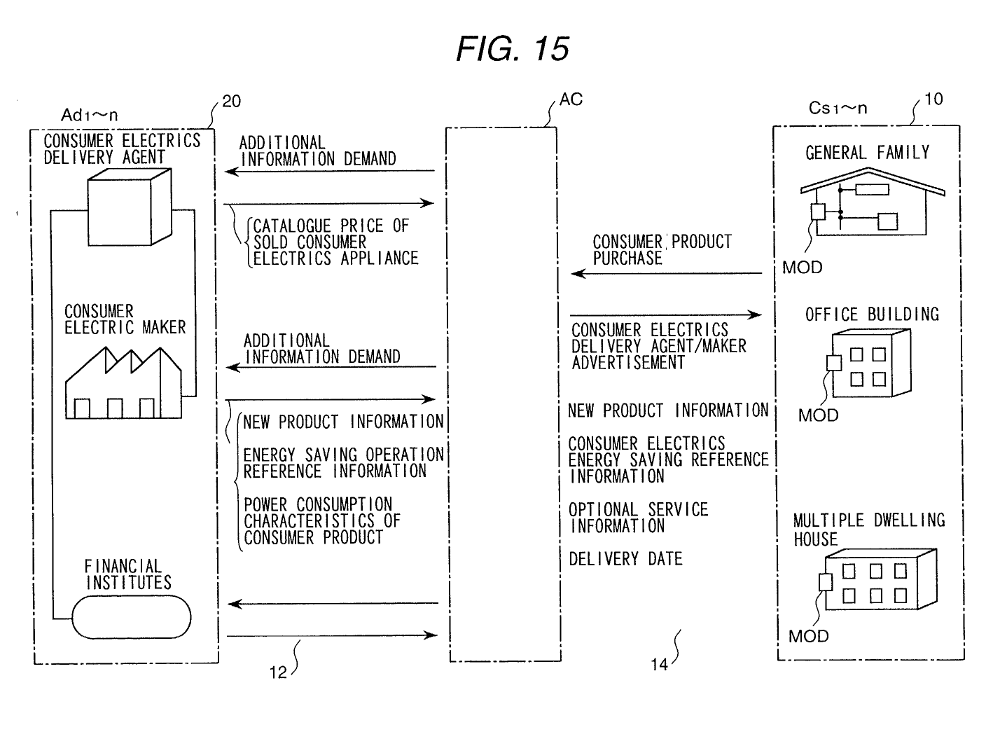

FIG. 13 is a flowchart for discussing about calculation of charge to be billed to the advertiser. Basically, manner of charge calculation is the same as that for the customer as illustrated and discussed in FIG. 11. At step, data within the predetermined period for which the charge is to be calculated is extracted. At step 104, number of times of access to the advertisement information of the advertiser corresponding to those shown in FIG. 10 is checked per each retrieval depth as shown in FIGS. 14A and 14B. In addition, additional advertisement information other than those registered in the service center AC is also counted depending upon levels thereof. FIG. 14A is a table of access per advertiser. Here, for convenience of disclosure, access data of the advertiser Ad1 will be taken as example. A column “advertisement rank” represents rank of advertisement contract established between the service center AC and the advertiser. As can be seen from FIG. 14B, memory capacity to be used for storing advertisement information and unit access charge are variable depending upon the advertisement rank. In the shown example, the memory capacity permitted for the advertiser of the advertisement rank B is less than b bytes which is greater than a bytes which s permitted for the advertiser of the advertisement rank A. Next three columns in FIG. 14A show number of times of access to the advertisement information at different retrieval depths. As basic idea, for the advertiser, greater number of access to own advertisement information shows higher interest to their products or commercial article to potentially contribute for better sales. Therefore, the advertiser should agree to pay higher advertisement charge for greater number of access. Similarly to the case of customer, the unit of charge per information may be variable depending upon depth of retrieval.

In the shown example, it is assumed that, for advertisement of the advertiser Ad1, one hundred times of accesses have been made in the retrieval depth 1, fifty times of accesses have been made in the retrieval depth 3, and thirty times of accesses have been made in the retrieval depth 5. Therefore, charge for the advertiser Ad1 is calculated by (1×100+3×50 and 5 ×30)=400. Therefore, charge to the advertiser may be calculated with taking the retrieval depth into account. It should be noted that this process for calculating charge on the basis of number of times of access at different retrieval depth corresponds to the process at step S106 as set forth above. Also, occurrence of additional advertisement is also checked per respective levels for calculating the special charges. In the shown case additional advertisement is provided for thirty times at level 6 and twenty times at level 10. Therefore, special charge is calculated by 30×6+10×20 =380. This process corresponds to the process at step Silo). Therefore, total charge for the advertiser becomes 780 (=400+380). Then, by multiplying the calculated value by a charge for unit information amount, an actual charge for the advertiser Ad1 is determined. Finally, at step S144, check is performed whether charges are calculated for all advertisers or not. If not, the process returns to step S102 for repeating the foregoing process until calculation of charge is completed for all advertisers.

FIG. 15 illustrates another embodiment of the advertisement information providing system according to the present invention for providing advertisement information of electric products such as house hold electric appliance or the like for the customer (who is planning to or going purchase domestic electric appliance for family use or who is a owner or manager of office or multiple dwelling house planning or going to bulk buying the electric appliance).

While not definitely illustrated in FIG. 15, an information terminal MOD with a sensor is held by the customer 10 as customer for electric power. From the sensor, a power consumption amount of the customer for electrical power is transmitted to a power supplier. On the basis of power consumption data thus collected, a power consumption pattern of the customer 10 can be derived. The power consumption pattern is informed from the power supplier to the service center AC. It should be noted that this process of the power supplier may also be performed by the service center AC. On the other hand, it is preferred to provide sensor in each individual electrical product and a junction between a power supply cable of the power supplier and the customer's domestic power circuit. By measuring power consumption per each electrical product, power consumption characteristics of each electrical product can le derived by analysis to permit advertisement of electrical product with smaller power consumption.

As demanded by the customer as customer for electric power, the service center AC selects information adapted to the customer among power consumption pattern for providing information by facsimile transmission through a communication line or by homepage. Permission of access to the homepage is performed with taking an identifier as key with assigning identifier for each customer of electrical power. It should be noted that information adapted to the customer means useful information for the customer, such as power consumption curve of each electrical appliance, a correlation model of power consumption and room temperature in case of air conditioner, model of use of electrical appliance, consumption characteristics with taking inhabited area, family structure, income, profession, holding electrical appliance and so forth, advertisement information of electrical appliance adapted to the consumption characteristics.

This is a construction which can be achieved only when the service center AC, the consumer electronics maker and delivery agent are connected by information circuit. Accordingly, as viewed from the customer, the service center AC appears as delivery agent and maker and also as information provider including these. For example, upon purchasing house hold electrical appliance, the product can be purchased with making reference to various analyzed trend data with interaction with the advertisement service center AC. This can be achieved only when the customer and the advertisement service center are connected by information circuit. In the embodiment shown in FIG. 15, the customer and the delivery agent is also connected to a financial institutions, such as banking institutions, credit institutions. This arrangement is quite convenient for both of the customer and the delivery agent.

As set forth above, the shown embodiment is the advertisement service system which intervening between the customer and the advertiser to provide necessary information to the customer. As viewed from the customer, it is beneficial for capability of obtaining information adapting to the own consumption characteristics, particularly advertisement information, without inputting particular input. On the other hand, it is also true for the advertiser, since advertisement information adapted to the customer can be provided without providing unnecessary information. For instance, for the customer living along, advertisement information of small size or middle size refrigerator is provided instead of that of the large size refrigerator. Therefore, the shown embodiment of the system is beneficial both for the customer and the advertiser.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An advertisement providing method for providing advertisement from an advertiser to an electric power customer comprising the steps of:
receiving a power consumption data from a sensor measuring a power consumption amount of said electric power customer or from an electric power supplier; and
selecting an advertisement to be provided to said electric power customer from preliminarily registered in a database on the basis said power consumption data.

2. An advertisement providing method as set forth in claim 1, wherein the selected advertisement is provided to said electric power customer through a communication circuit.

3. An advertisement providing method as set forth in claim 2, wherein number of times of communication or a communication period is recorded and a charge calculation is performed depending upon recorded number of times of communication or communication period.

4. An advertisement providing method as set forth in claim 2, wherein providing of advertisement through said communication circuit is performed by one of placement on a homepage and transmission through facsimile.

5. An advertisement providing method as set forth in claim 3, wherein advertisement placed on the homepage is permitted by prompting input of an identifier for proving identity of said electric power customer, retrieving the input identifier against a database storing identifiers preliminarily assigned for said electric power customers, and enabling access to the homepage only when said input identifier is present in said database.

6. An advertisement providing method as set forth in claim 2, wherein the advertisement is provided in response to a demand of said electric power customer.

7. An advertisement providing method as set forth in claim 1, wherein said selection of advertisement is an advertisement of products assisting power saving of said electric power customer.

8. An advertisement providing system for providing an advertisement from an advertiser to an electric power customer comprising:
a receiving portion receiving a power consumption data from a sensor measuring a power consumption amount from the electric power customer or an electric power supplier;
a database storing advertisements of advertisers; and
means for selecting advertisement to be provided to the electric power customer among advertisements stored in the database on the basis of an electric power consumption data received by said receiving portion.

9. An advertisement providing system as set forth in claim 8, which further comprises database storing destination of transmission of advertisement per electric power customer for transmitting said selected advertisement to the transmission destination of the electric power customer.

10. An advertisement providing system as set forth in claim 9, wherein transmission of the advertisement is performed via facsimile.

11. An advertisement providing system as set forth in claim 9, wherein transmission of the advertisement is performed in response to a demand of said customer.

12. An advertisement providing system as set forth in claim 9, which further comprises:
means for recording number of times of transmission or transmission period in a recording medium; and
means for performing charge calculation depending on recording number of times of transmission or transmission period.

13. An advertisement providing system as set forth in claim 8, which further comprises means for placing said selected advertisement on a homepage.

14. An advertisement providing system as set forth in claim 12, which further comprises:
means for prompting input of an identifier indicative of identity of the electric power customer as access condition of the homepage placed thereon said selected advertisement;
database storing the identifier assigned for each electric power customer; and
means for enabling access of the homepage upon presence of the input identifier in said identifier storing database as a result of retrieval of input identifier against said database.

15. An advertisement providing system as set forth in claim 8, wherein said advertisement contains information of products or service consuming an electric power, and said selecting means selects advertisement of products lowering of power consumption amount of the electric power customer.

16. An advertisement providing method providing information from an advertiser by selecting information adapting to said customer in response to a demand for information from the customer from the customer, comprising the steps of:
checking whether a customer on access has a contract for using the information;
permitting access to the information when the customer holds contract for using the information, for permitting retrieval of information registered as advertisement information by an advertiser depending upon the demand of the customer;
optionally demanding additional information to the advertiser;
delivering resultant information to the customer; and
performing billing process for the customer and/or advertiser depending upon access record and delivery record of the customer.

17. An advertisement providing method as set forth in claim 16, wherein check is performed whether information retrieval demanded by the customer falls within a scope of contract for discriminating demand for information retrieval out of contract when the customer Is demand requires retrieval output contract, and performing billing process for retrieval out of contract during billing process.

18. An advertisement providing method as set forth in claim 16, wherein a depth of retrieval performed in response to the demand of the customer is recorded and billing is performed depending of the recorded depth of retrieval during billing process.

19. An advertisement providing method as set forth in claim 18, wherein a statistical analysis process is performed in response to a demand from the customer and a result of analysis is provided to said customer together with associated advertisement information.

20. An advertisement providing method as set forth in claim 19, wherein an additional information from the advertiser is registered in response to a demand from the customer, and an additional advertisement charge is billed to the advertiser.

21. An advertisement providing system for providing information to a customer with selecting information from an advertiser adapting to a demand from the customer in response the customer's demand, which advertisement providing system connected to said advertiser through a communication line, comprising an advertisement service center including:
a customer authenticating portion for checking whether the customer on access holds a use contract for permitting access only when said customer on access holds use contract;
an advertisement information storage file storing information registered by said advertiser as advertisement information for retrieval in response to demand from said customer;
an additional information demanding portion demanding additional information to said advertiser when said demand of the customer is not contained in said advertisement information storage file; and
a billing process portion performing billing process to said customer and/or advertiser on the basis of an access record and/or delivery record.

22. An advertisement providing system as set forth in claim 21, wherein said advertisement service center further includes a statistical analyzing portion performing statistical analysis process depending upon demand of the customer.

23. An advertisement providing system as set forth in claim 22, wherein said advertisement service center further includes a customer billing process portion performing billing process on the basis of a record of access within a contract or out of contract.
